(19) United States
(12) Patent Application Publication
(10) Pub. No.: US 2012/0101938 A1
(43) Pub. Date: Apr. 26, 2012

(54) METHOD AND SYSTEM FOR SECURE ONLINE PAYMENTS

(76) Inventor: Sheldon Kasower, West Hills, CA (US)

(21) Appl. No.: 13/104,725

(22) Filed: May 10, 2011

Related U.S. Application Data
(60) Provisional application No. 61/406,335, filed on Oct. 25, 2010.

(51) Int. Cl. G06Q 40/00

(52) U.S. Cl. 705/39; 705/35

(57) ABSTRACT

Methods and devices are provided for secure online payments. In one embodiment, the method may involve receiving log-in information for a user. The method may involve accessing data regarding open credit card accounts for the user from a credit information entity, in response to the received log-in information matching stored authentication information. The method may involve sending secure account information about the open credit card accounts to at least one network entity (e.g., a registration server, a user device, or a merchant server). The method may also involve, in response to the user selecting a given one of the accounts from the secure account information, determining whether sufficient credit is available for the selected given account and processing a transaction with the selected given account.

### CROSS-REFERENCE TO RELATED APPLICATIONS

This application claims the benefit of U.S. Provisional Application No. 61/406,335, filed Oct. 25, 2010, which is hereby expressly incorporated in its entirety by reference herein.

### BACKGROUND

1. Field

The present application relates generally to online transactions, and more specifically to systems and methods for reducing the risk of credit card data theft associated with online transactions.

2. Background

Traditionally, online payments with credit cards involve the entry of credit card data (e.g., credit card number, expiration date, security code, cardholder name, billing address, etc.) at a given web site, such as, for example, at an online or electronic commerce (e-commerce) merchant site, payment processing site (e.g., PayPal), or the like.

Known online transaction systems and methods typically involve having the user enter his or her credit card data at a website or via a mobile application, which in turn may involve transmitting the credit card data over the Internet. While there have been some improvements to securing connections between computers that send or receive sensitive information (e.g., credit card data), such information may become susceptible to interception when transmitted between nodes on the Internet. In addition, other risks associated with online transactions include keystroke logging technologies (hardware and software-based) that make it possible to track or log the keys struck on a keyboard, typically in a covert manner so that the person using the keyboard is unaware that their actions are being monitored. Accordingly, it would be desirable to allow online customers and merchants to conduct online transactions without having the customers enter and send their credit card data over the Internet.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with methods for secure payment processing. In one approach, the method may be performed by a registration server in an e-commerce network. For example, the method may involve receiving registration information from a user. The method may involve authenticating the user based at least in part on the received registration information. The method may involve gathering data regarding open credit card accounts for the user. In related aspects, gathering may involve accessing the data from a credit information entity (e.g., pulling the credit report from a credit bureau server). In the alternative, or in addition, gathering may involve receiving the data from the user (e.g., having the user input information regarding the open credit card accounts). In further related aspects, an electronic device may be configured to execute the methodology described above.

In accordance with one or more embodiments and corresponding disclosure thereof, various aspects are described in connection with a secure payment method operable by an authentication server in an e-commerce network. For example, the method may involve receiving log-in information for a user. The method may involve, in response to the received log-in information matching stored authentication information, accessing data regarding open credit card accounts for the user from a credit information entity, such as, for example, a credit bureau. The method may involve sending secure account information about the open credit card accounts to at least one network entity (e.g., a registration server, a user device, and/or a merchant server). In related aspects, the method may further involve, in response to the user selecting a given one of the accounts from the secure account information, determining whether sufficient credit is available for the selected given account. The method may also involve, in response to verifying availability of the sufficient credit, processing a transaction with the selected given account (e.g., sending information regarding the selected given account and the transaction to a payment processing engine). In further related aspects, an electronic device may be configured to execute the methodology described above.

In accordance with one or more embodiments and corresponding disclosure thereof, various aspects are described in connection with a secure payment method operable by a user device. For example, the method may involve receiving log-in information from a user and sending the log-in information to an authentication server. The method may involve, in response to the log-in information matching authentication information at the authentication server, receiving data regarding open credit card accounts for the user. The method may involve displaying secure account information about the open credit card accounts based at least in part on the received data. In related aspects, the received data is based at least in part on a credit report for the user pulled from a credit bureau server and/or user-provided information. In further related aspects, an electronic device may be configured to execute the methodology described above.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is a block diagram of an exemplary secure payment system.

FIG. 2A illustrates an example online merchant site.

FIG. 2B is a block diagram of one embodiment of a system for securely selecting a credit card for an online payment.

FIG. 3 provides a general flow diagram for using the system of FIG. 2B.

FIG. 4A illustrates an example sign up process for an embodiment of a secure online payment system.

FIG. 4B illustrates an example of a member sign up page.

FIG. 4C illustrates an example of an account management page.

FIG. 5A shows an example method for having the user sign up for a secure payment account.

FIG. 5B is an example screen shot of information displayed to a user signed in to the secure payment account.

FIG. 5C is an example screen shot of a secure payment system prompting the user to enter further details regarding card accounts.

FIG. 5D is an example screen shot of a secure payment system prompting the user to enter security information.

FIG. 5E shows an example method by which a merchant may set up a secure payment processing service.

FIG. 6A illustrates an example of how the user and the secure payment system may conduct an online transaction at a merchant's website.

FIG. 6B is an example screen shot of a secure payment member home page.

FIGS. 6C-E are example screen shots of secure payment member pages from which the user can control cash transfers.

FIG. 7 illustrates an example methodology operable by a registration server/device for secure online payments.

FIG. 8 shows further aspects of the methodology of FIG. 7.

FIG. 9 illustrates an example methodology operable by an authentication server/device for secure online payments.

FIG. 10 shows further aspects of the methodology of FIG. 9.

FIG. 11 illustrates an example methodology operable by a user device for secure online payments.

FIG. 12 shows further aspects of the methodology of FIG. 11.

FIG. 13 shows an example apparatus for secure online payments, in accordance with the methodology of FIGS. 7-8.

FIG. 14 shows an example apparatus for secure online payments, in accordance with the methodology of FIGS. 9-10.

FIG. 15 shows an example apparatus for secure online payments, in accordance with the methodology of FIGS. 11-12.

### DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) can be practiced without these specific details. In other instances, well-known structures and devices are shown in block diagram form in order to facilitate describing one or more embodiments.

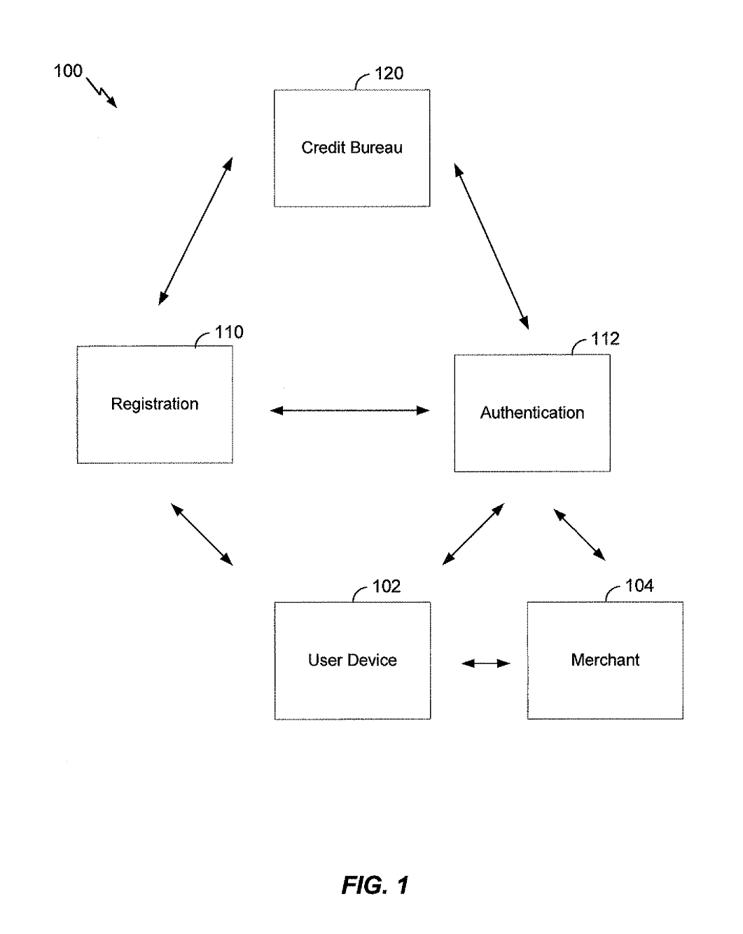

The techniques described herein may be used for or within various online or electronic commerce (e-commerce) systems, sub-systems, and/or components thereof. With reference to FIG. 1, there is shown one embodiment of a secure payment system 100 that may comprise a plurality of system entities, such as, for example, a user device 102 in operative communication with a registration server 110 and an authentication server 112. The registration server 110 and the authentication server 112 may be in operative communication with each other, and may be in operative communication with a credit bureau server 120 of a credit bureau. The system 100 may further comprise a merchant computer 104 in operative communication with the user device 102 and the authentication server 112. For example, the credit bureau may be a credit card processor that submits the charge on behalf of the merchant. In another example, the credit bureau may be a credit card processor that provides the functionality to a processor. In both examples, the charge may be credited to the merchant.

It is noted that, in other embodiments, some of the system entities may not be in operative communication with each other. It is further noted that, in other embodiments, one or more of the system entities may be combined or may be part of another system entity. For example, the registration server 110 and the authentication server 112 may be combined into a single system entity.

In related aspects, one or more of the system entities may comprise a computing device, server, wired or wireless communication device, or any other machine/device capable of communication with a computer network. In further related aspects, one or more of the system entities may communicate with each other a communication network, such as the Internet, preferably via secured connections or links.

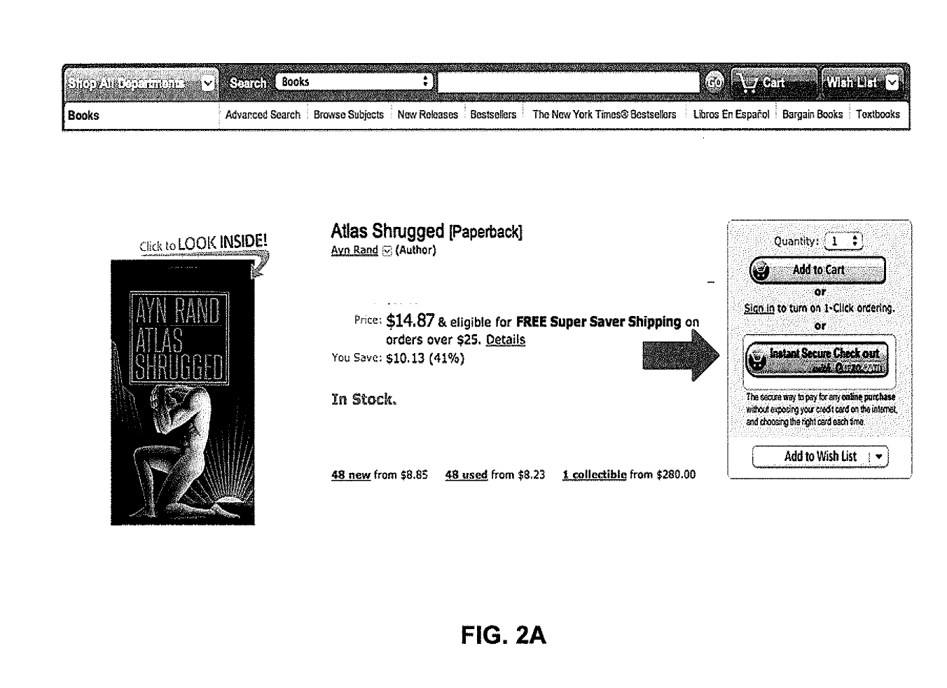

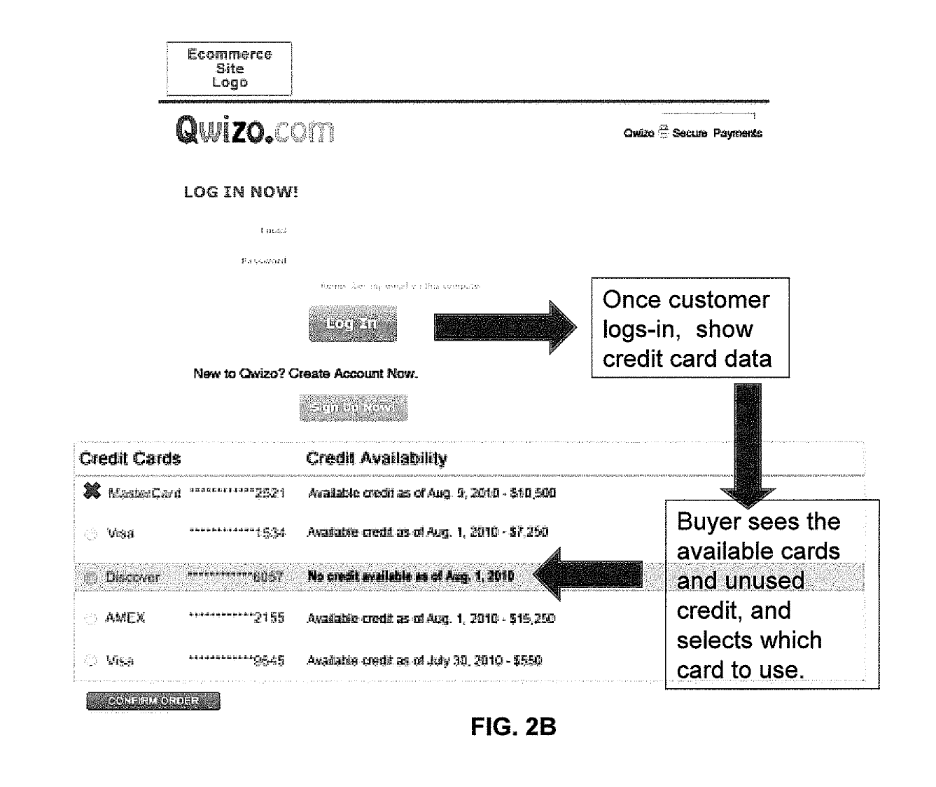

Referring to FIG. 2A, an exemplary online merchant site is shown. The online merchant site (e.g., Amazon.com or eBay.com) typically includes a checkout button or link to a payment processing site, which may or may not be affiliated with the merchant site. In the embodiments shown herein, the checkout button is for a secure payment system/service referred to as Qwizo.com.

With reference to FIG. 2B, there is shown one embodiment of a system for allowing a user to securely select a credit card from a list for an online payment. The user may be presented with a login page or site that includes fields for the user to enter a user identification (e.g., email address) and password. Once the user enters the requisite information and logs-in, credit card data may be displayed to user. The buyer sees the available credits card(s), and if more than one is listed, selects which card to use. Information regarding each card, such as, for example, availability data, unused credit, card status, or the like, may also be displayed to the user, thereby allowing the user to make an informed decision about which card to use. Such information may also keep the user informed of lost or stolen credit cards, as unusual changes to the availability data would be reflected in the credit card data.

In related aspects, the credit card data displayed to the user may be in the form of secure account information. The secure account information may be based on or include parts of data regarding open credit card accounts from a credit card report for the user. The data may be pulled from or accessed at a credit bureau server or the like. For example, the secure account information may be a subset of the pulled data. The subset of the pulled data may be truncated versions of credit card numbers. The truncated versions may be the last four digits of the credit card numbers or the like.

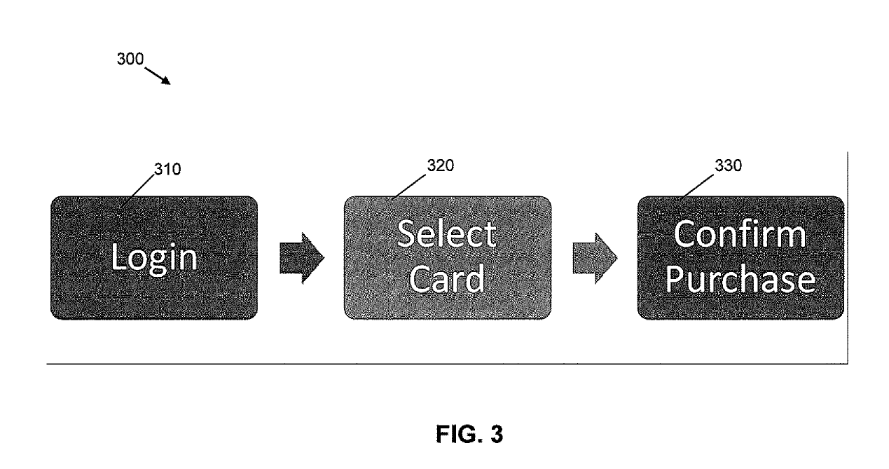

With reference to FIG. 3, there is shown a summary of online purchasing process 300 according to the secure payment service described herein. Described generally, the process 300 may involve, at 310, having the user or customer log-in to his/her account on the secure payment system. The process 300 may involve, at 320, allowing the user to select a credit card to use, which in turn may involve pulling credit card data from a credit bureau site and displaying the credit card data to the user may as secure account information, as described above. The process 300 may involve, at 330, allowing the user to confirm the purchase.

In related aspects, the techniques of process 300 may be used on any e-commerce website. The user may select the present secured transaction service, as they would with PayPal or a credit card. However, no credit card data entry by the user is required, thereby preventing the transmission of user-entered credit card data across the Internet.

In further related aspects, the techniques of the secure payment service described herein gives customers a safe and secure way to make online purchases. The techniques described herein allow customers to make purchases online using credit card information from their credit report. The techniques described herein allow customers to monitor their credit card data and stay informed regarding changes to their credit availability, and also allow the user to report lost or stolen credit cards.

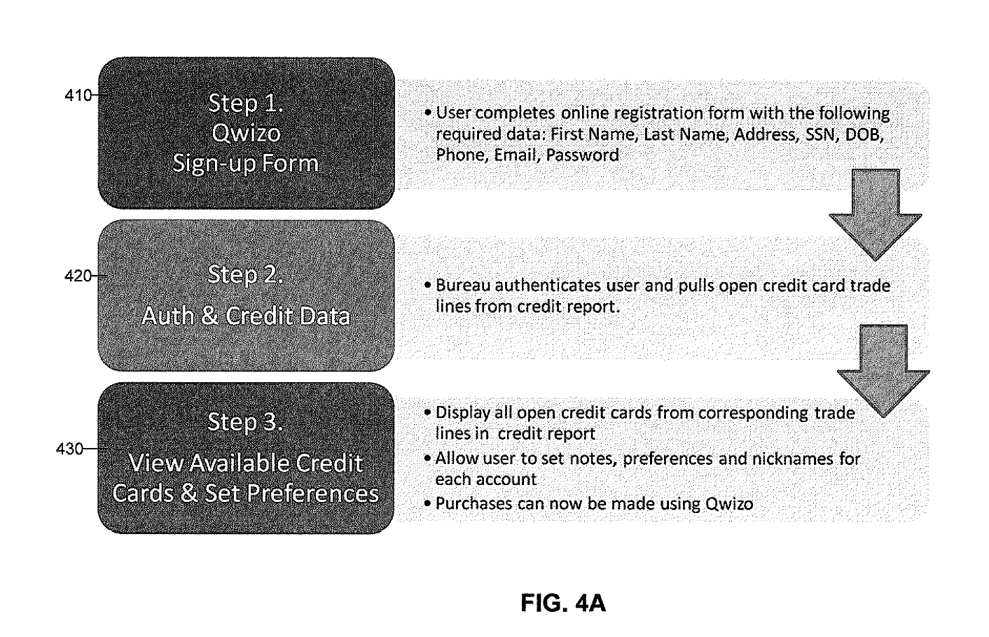

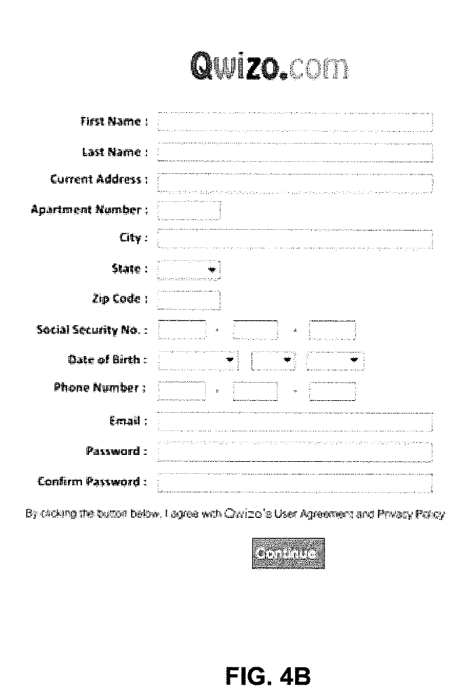

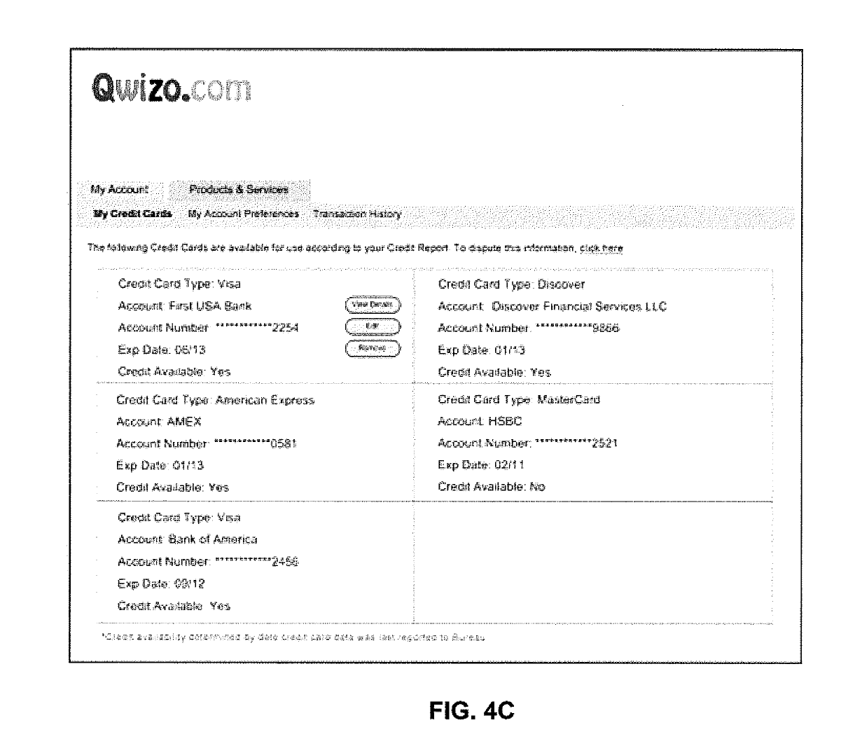

With reference to FIG. 4A, there is shown a summary of an embodiment of a sign up process 400 for the secure payment service. The process 400 may involve, at 410, providing the user with a sign up form. The user may complete an online registration form with data, such as, for example, first name, last name, address, social security number, date of birth, phone numbers, email address, password, etc. An example of a member sign up form or page is shown in FIG. 4B.

With continued reference to FIG. 4A, the process 400 may involve, at 420, authenticating the user and communicating with a credit bureau or the like to obtain credit data for the user. The credit bureau may authenticate the user and may pull open credit card trade lines from a credit report or the like. At 430, the process 400 may involve allowing the user to view available credit cards and optionally set preferences. For example, the secure payment system may display open credit cards from corresponding trade lines in the credit report. The system may allow the user to set notes, preferences, and/or nicknames for each account. Purchases can then be made using the secure payment service.

In related aspects, an account management page may be displayed to the user to allow the user to view available credit cards and/or set preferences. An example account management page is shown in FIG. 4C.

In view of exemplary systems shown and described herein, methodologies that may be implemented in accordance with the disclosed subject matter, will be better appreciated with reference to various flow charts. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

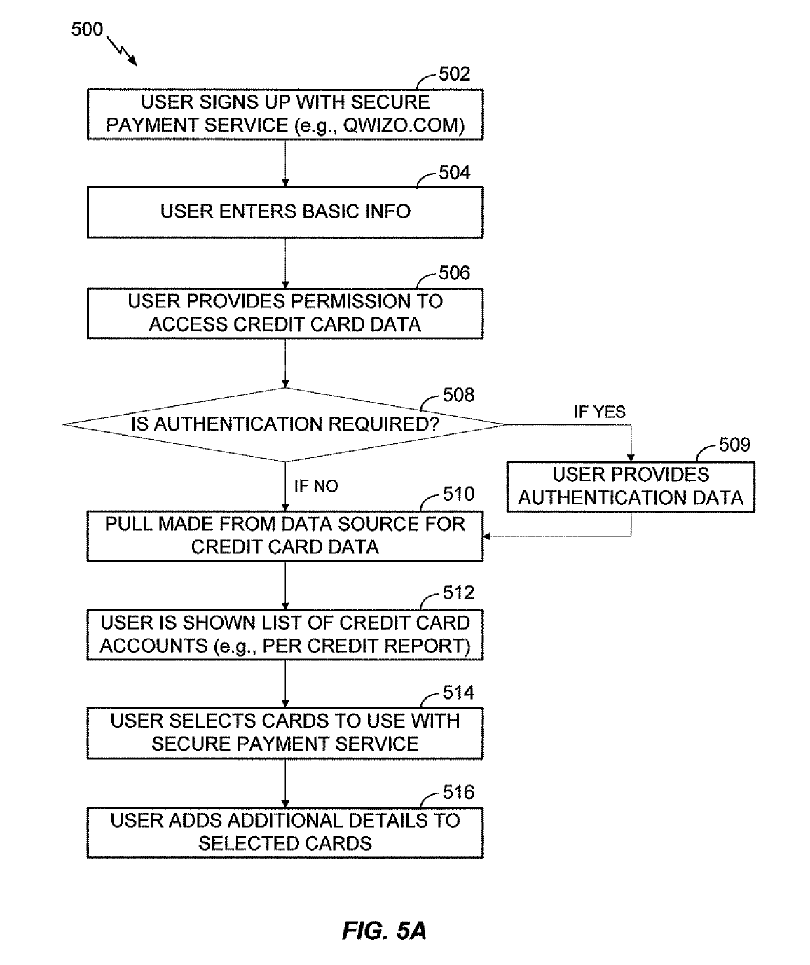

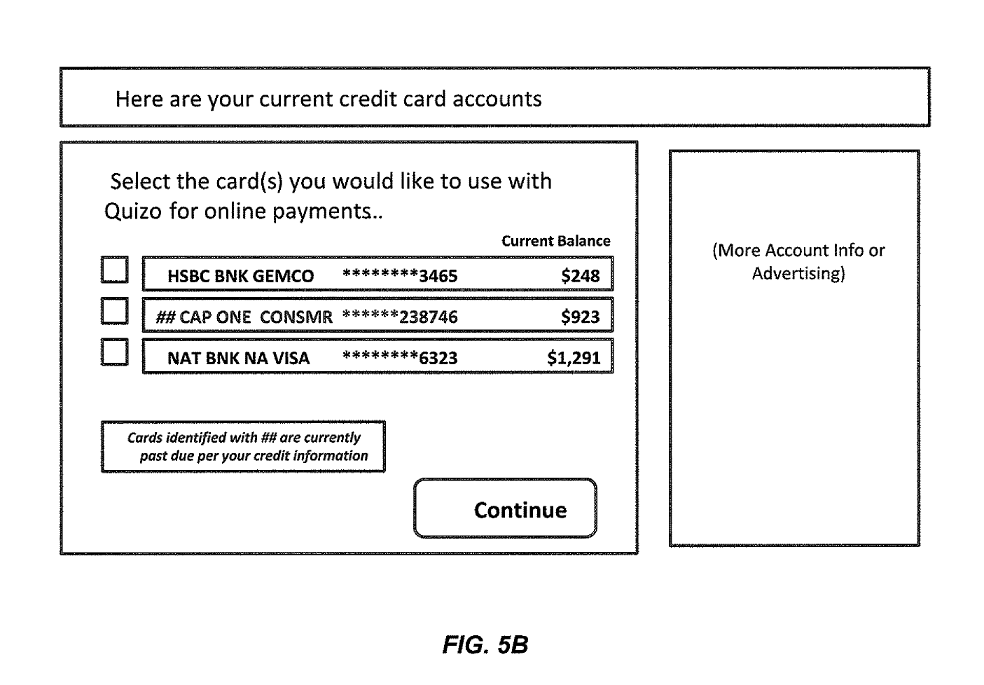

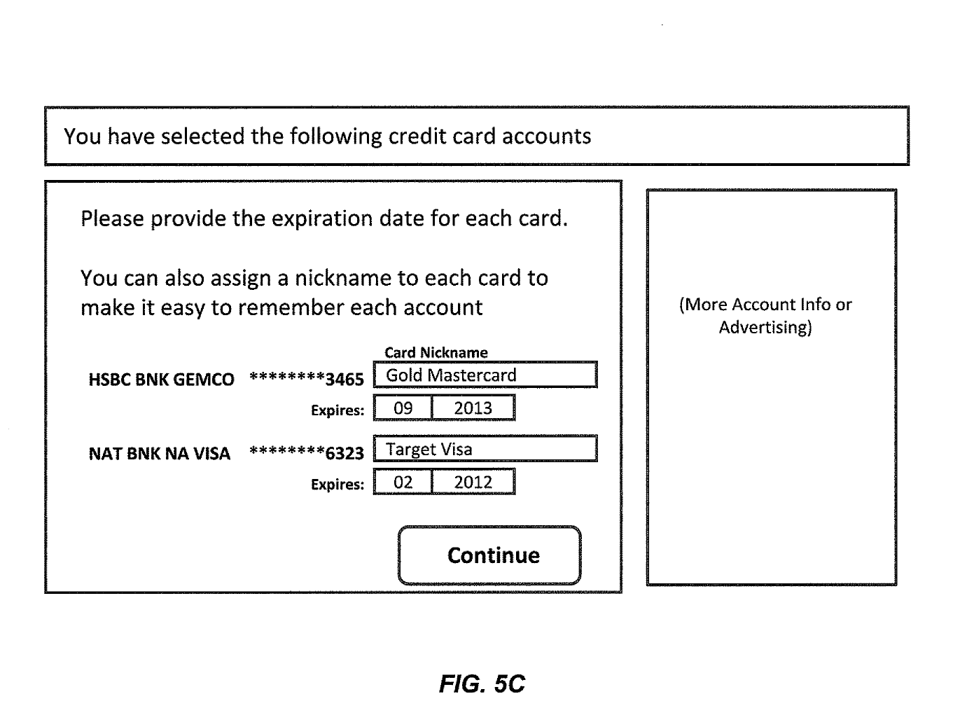

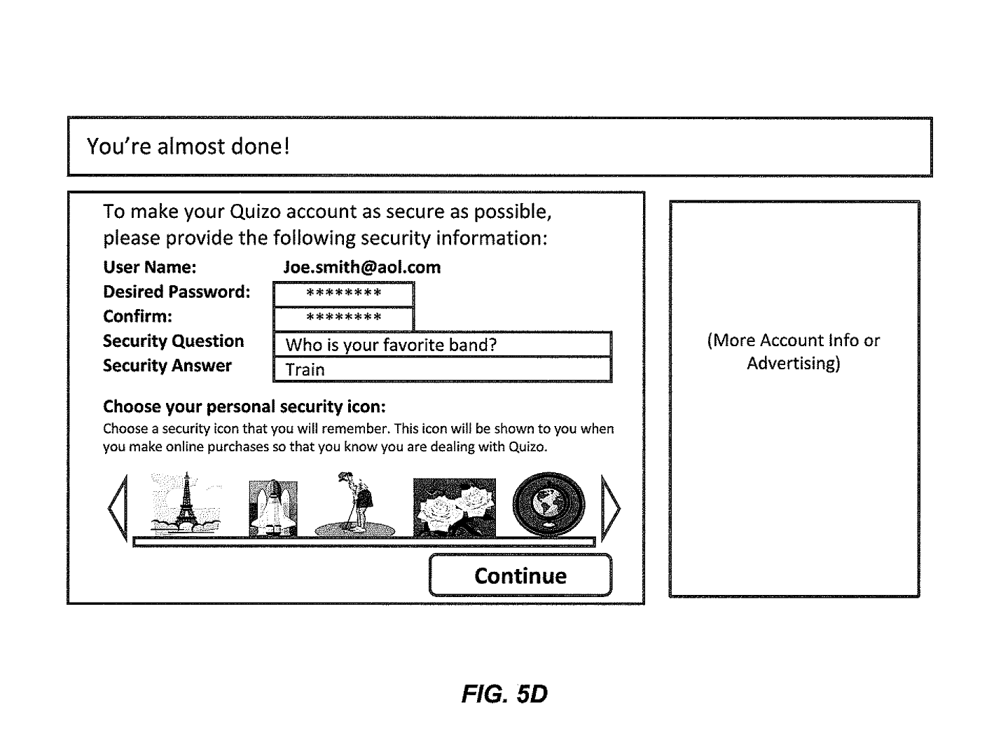

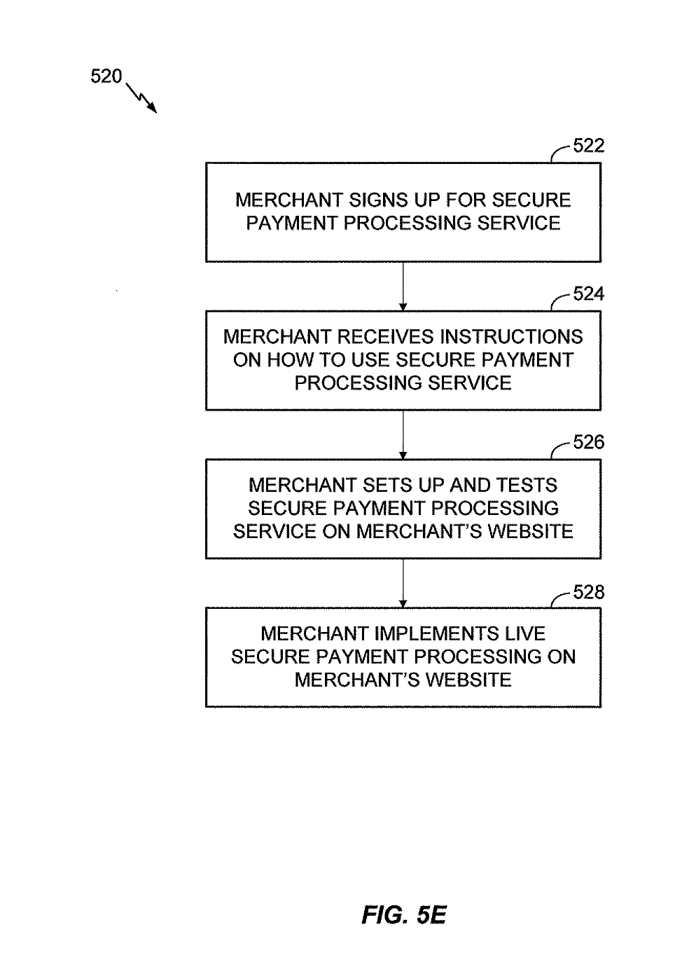

In accordance with one or more aspects of the embodiments described herein, the secure payment techniques described herein involve (a) having the user sign up a secure payment account, (b) having the merchant set up to the secure payment processing service, and (c) having the user select and use the secure payment service on the merchant's website. With reference to FIG. 5A, there is shown an embodiment of a methodology 500 for having the user sign up a secure payment account. At 502, the user may select to sign up for the secure payment service. At 504, the user may enter basic information, such as, for example, name, address, email, phone, social security number or other unique identifier, date of birth, security information (e.g., user name, password, selected security icon, etc.). It is noted that the secure payment system or a given component thereof may verify the user provided information (e.g., email address), such as by clicking on a link in a confirmatory email, Short Message Service (SMS) message, or the like. At 506, the user may provide permission to access or pull data regarding open credit card accounts (e.g., from a credit report), and/or may provide such data regarding open credit card accounts.

For example, if the user provides permission to pull data regarding open credit card accounts, the method 500 involves, at 508, having the secure payment system determine whether authentication is required. If so, at 509, the requisite authentication data may be provided by the user and, at 510, a pull is made from a data source for credit card data (e.g., a credit bureau or credit information entity/group), wherein the credit card data may include card names, card numbers (e.g., masked), account statuses (e.g., open, closed, over the limit, past due, collection, etc.), current balances, current payment amounts, etc. If not, the pull may be made from the data source without authentication. In related aspects, the secure payment system may assign a unique PIN to each card account pulled from the data source. In further related aspects, the user may provide credit card data to be used in conjunction with, or in lieu of, the pulled credit card data.

At 512, the user may be shown a list of credit card accounts according to the information or report pulled from the data source. In related aspects, the user may be shown balances on his/her cards (e.g., per latest balance reported on the pulled data, such as a credit report or the like) at the time of the online transaction at the merchant's website. An example of the information displayed to the user is illustrated in the embodiment of FIG. 5B.

With reference once again to FIG. 5A, at 514, the user may select which card accounts to use with the secure payment service (i.e., the user may select one of his/her card accounts authorized by the secure payment system). For example, closed or collection accounts may be excluded from use with the secure payment service. In addition, or in the alternative, accounts not shown on the pulled report may be excluded. At 516, the user may add further details regarding selected cards accounts, such as, for example, a cross-reference identifier (e.g., an Experian ID for a given account), a card nickname, an expiration date, permission for other secure payment service users to transfer cash to a given card, etc. The secure payment system may prompt the user to enter further details regarding the selected card accounts, as shown in FIG. 5C. The secure payment system may also prompt the user to enter provide security information (e.g., password, security question, and security answer), and/or to select a security icon that is displayed to the user when making online purchases (so that the user knows that he/she is interfacing with the secure payment system, rather than a fraudulent or phishing website that is trying to pass itself off as the secure payment system), as shown in FIG. 5D. In another embodiment, details (e.g., expiration dates) regarding the selected card accounts may be obtained or received from a third-party entity/source, so that the user does not have to add/update them. For example, the expiration date and/or other details for one or more of the card accounts may be automatically updated by the third-party entity. This would add an additional layer of security since the user would enter little to no card information when setting up the secure payment account and/or when using the secure payment account for an online transaction.

In related aspects, the user may select notification preferences about his/her secure payment account and/or associated credit card accounts. In further related aspects, the online transactions are not limited to the purchase of goods or services on the merchant's site. For example, the online transactions may generally involve cash transfers (e.g., at an online auction site) that may include incoming cash to the user's secure payment account or outbound cash to other secure payment accounts. The user may decide which other users have access to given ones of his/her card accounts (e.g., for inbound cash transfers or purchases).

With reference to FIG. 5E, there is shown an embodiment of a methodology 520 for having the merchant set up a secure payment processing service. At 522, the merchant may initiate signing up for the service. At 524, the merchant may receive instructions on how to implement and use the service on the merchant's website. At 526, the merchant may incorporate and test the service on the merchant's website according to the received instructions. At 528, the merchant may implement live secure payment processing according to the service. The merchant's benefits may include, but are not limited to, a secure payment processing service that works with different payment processors to provide multiple sources of payment, and the fact that there is no storing of credit card information by the merchant.

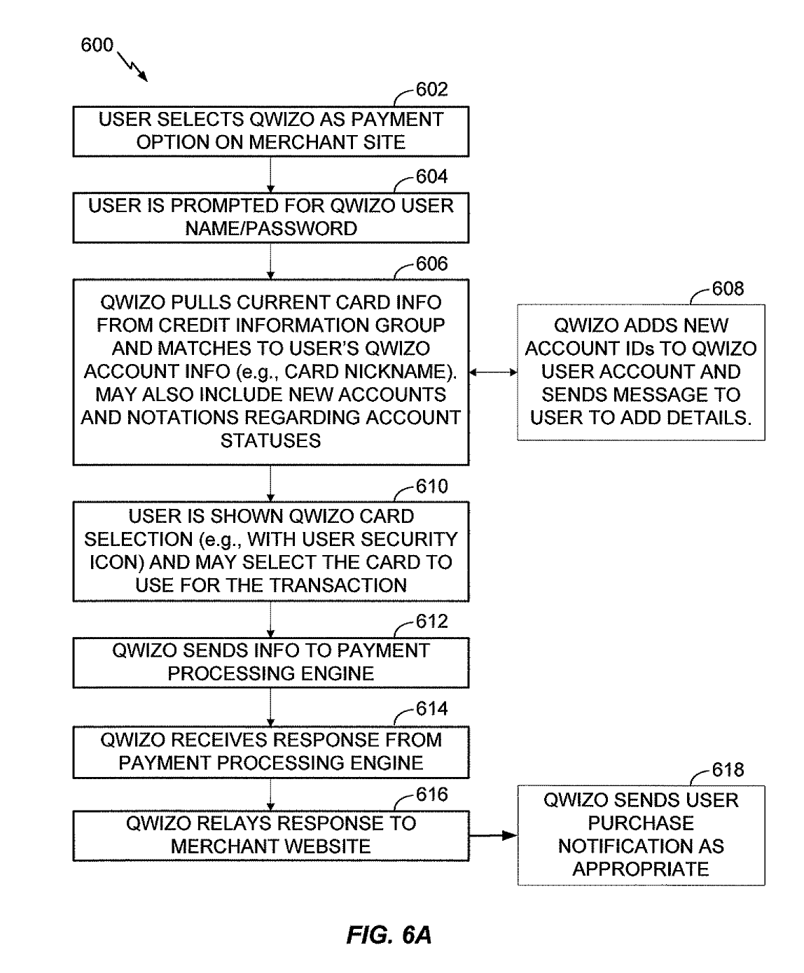

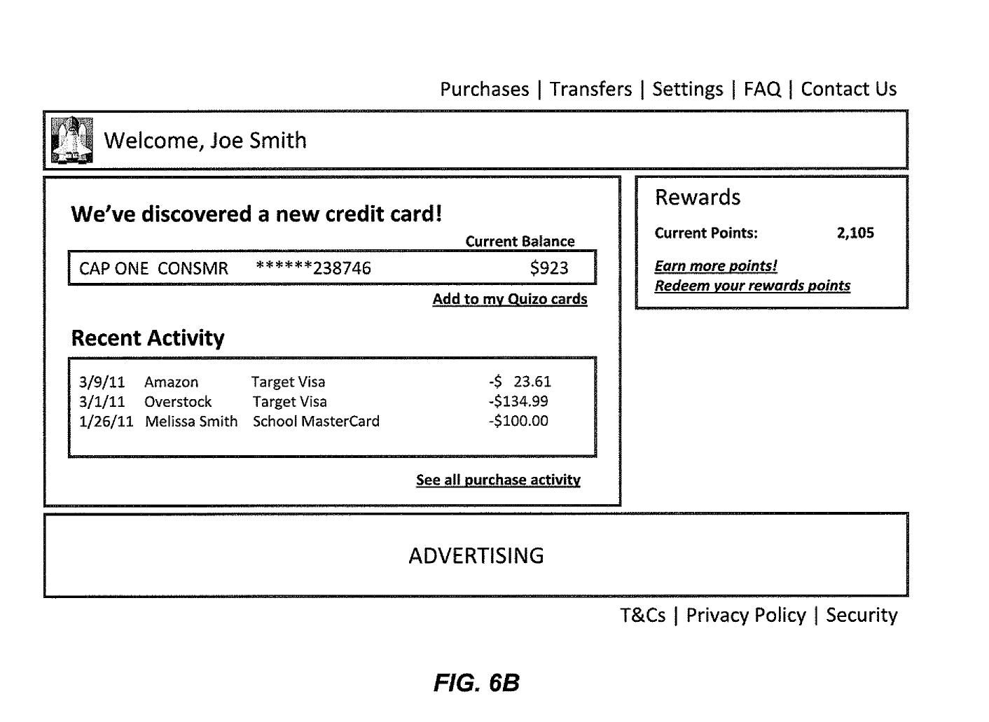

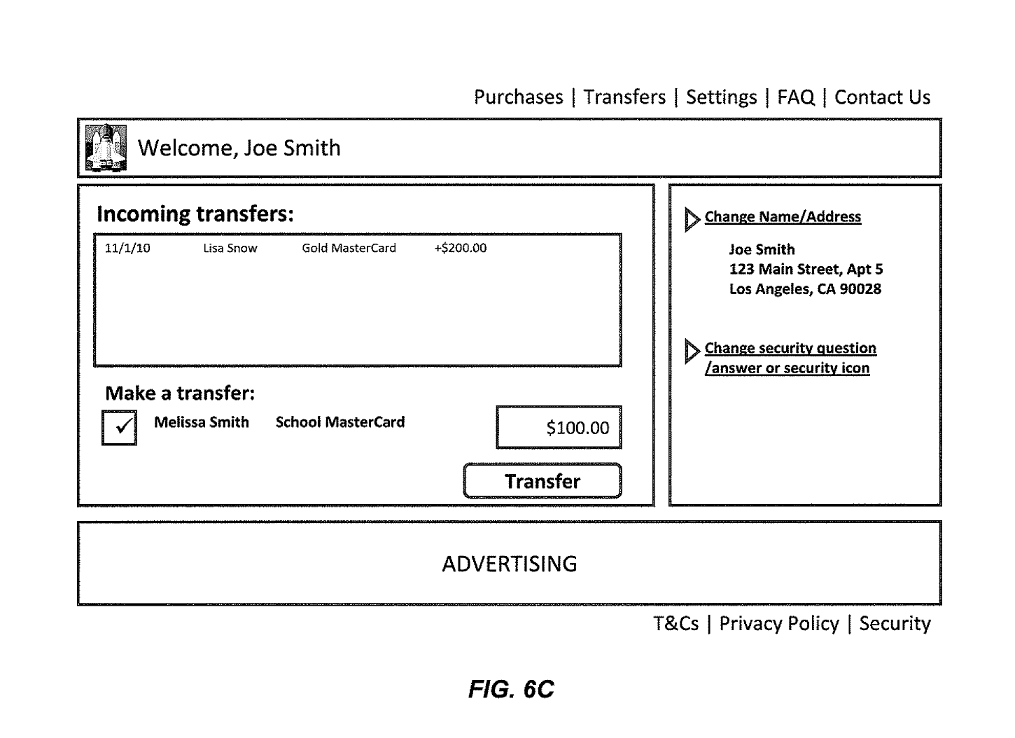

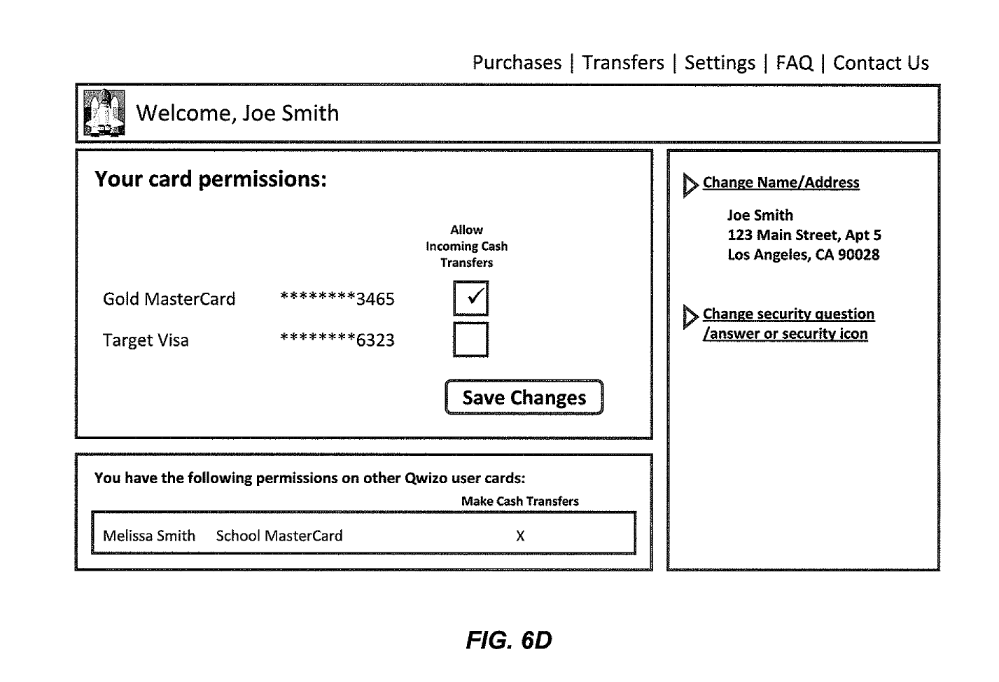

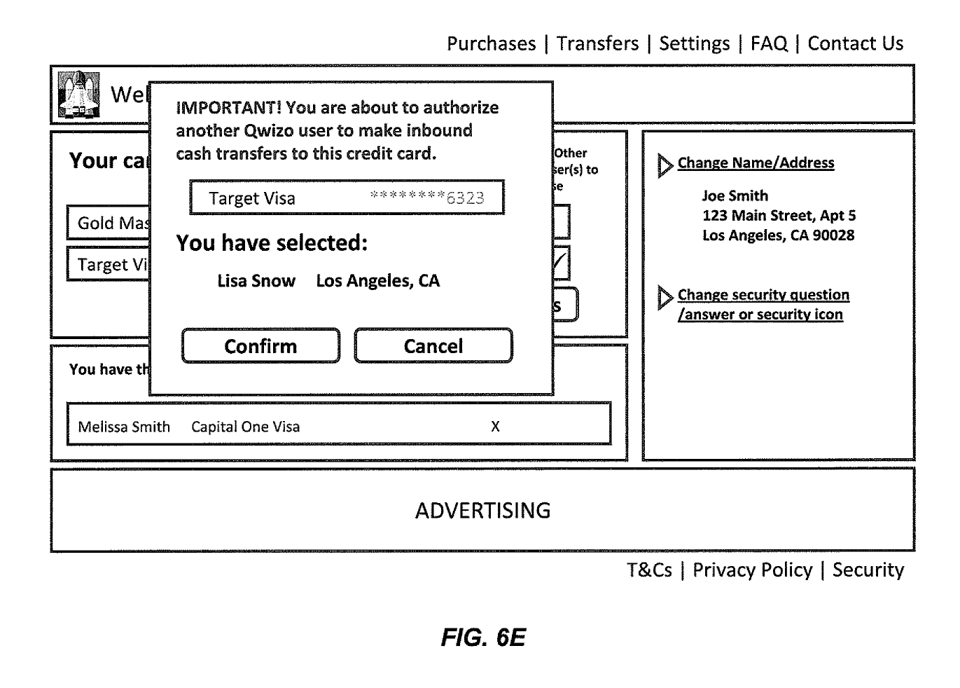

With reference to FIG. 6A, there is shown an embodiment of a methodology 600 for having the user select and use the secure payment service on the merchant's website, assuming that the user has already signed up for a secure payment account and that the merchant has set up the secure payment service on the merchant's website(s). At 602, the user may select the secure payment service option (e.g., “Qwizo”) on a merchant's website. At 604, the user may be prompted for a user name or ID and password. It is noted that the merchant may transmit the user's basic information (e.g., email address) to the secure payment system/service so that the system can show a security icon for security purposes. It is further noted that a device identifier for the user's device (e.g., mobile device, laptop, etc.) may be used in conjunction with the user ID and password to authenticate the user.

At 606, in response to the user being found or authenticated, the secure payment system may obtain the current credit card information for the user and update the user's secure payment account. For example, the secure payment system may pull the current credit card information from a credit bureau or credit information entity (e.g., Experian), and match the pulled information to the user's secure payment account (e.g., card nickname, expiration date, etc.). The secure payment system may add new card accounts and/or notations regarding the status of the user's card accounts tied to the user's secure payment account. In one embodiment, the secure payment system may display a secure payment member home page to the user, as shown in the example screen shot of FIG. 6B. As shown, the secure payment member home page may include a notification regarding a new card account (obtained in block 606) that the user may add to the list of cards authorized for use with the secure payment system. The secure payment member home page may include a summary of recent activity, as well as the option of seeing more or all purchase/transactions activity. In related aspects, the secure payment system may provide an incentive for customers to use its secure payment service by awarding frequent user points or awards. If there is a rewards/points program or promotion associated with the user's secure payment account, the secure payment member home page may display information regarding the user's current points or a link to such information. In addition, advertising may be displayed on the secure payment member home page.

With reference once again to FIG. 6A, at 608, the secure payment system may optionally add new account IDs to the user's secure payment account and send emails or SMS messages to the user asking him/her to verify the new card accounts and/or add further details regarding the new card accounts. A unique PIN may be assigned to each card account for communication with the credit bureau. In related aspects, a notice may be sent to the user when a new card account is detected at block 606. The user may be directed to a secure payment site to login and add details for the newly detected card account. If the new card account is selected for use during the transaction, the secure payment system may save pertinent details (e.g., expiration date) entered by the user at the time of the transaction. In further related aspects, the expiration date and/or other pertinent detail(s) may be obtained or received from a third-party entity's server or the like, so that the user does not have to enter them.

At 610, the user may be shown a list of card accounts associated with his/her secure payment account, and the user may select the card to use for the transaction. At 612, the secure payment system may send the transaction information to a payment processing engine associated with the selected card. For example, the transaction information may include details regarding the purchase date/time, the merchant, the amount, and the card account (e.g., the nickname of the card account selected for the transaction). At 614, the secure payment system may receive a response from the payment processing engine. At 616, the secure payment system may relay the response to the merchant's website. The response may include or be appended with a identifier for the user-selected card account such that the merchant may initiate credits/refunds without the user having to sign in. At 618, the secure payment system may notify the user (e.g., via email, SMS messaging, and/or phone call) regarding the purchase as appropriate. The notification may include the transaction information and a request to contact the secure payment system immediately if the user did not authorize the transaction. The notification to the user may include information regarding purchases, card expirations, newly opened card accounts, card accounts being closed or past due or in collection, and card balances or over the limit warnings. The notification may indicate changes to the user's secure payment account generally, such as, for example, that permission has been granted, changed, or revoked for purchase rights. The notification may indicate that purchase limit has been reached for using ones of the card accounts for the secure payment account. The notification may relate to an upcoming expiration date for a given card account, and may include a request to update card account information (e.g., a new expiration date).

As mentioned previously, involvement of the secure payment system in online transactions is not limited to the purchase of good or services at a merchant's website. As shown in FIG. 6C, the user may configure and use his/her secure payment account for transfers of cash or credit to/from other secure payment account users. For example, the secure payment system may provide a page to the user that includes a field summarizing incoming transfers (e.g., $200 to the user's Gold MasterCard from Lisa Snow), as well as a separate filed that allows the user to make an outgoing transfer (e.g., $100 to Melissa Smith's School MasterCard). With reference to the screen shot of FIG. 6D, the user may modify which of his/her cards may receive incoming cash transfers. For example, the user may permit additional cards (e.g., Target Visa) to receive incoming cash transfers from other authorized users (e.g., Lisa Snow in Los Angeles, Calif.) of the secure payment system, as shown in the screen shot of FIG. 6E. In related aspects, a notification (e.g., via email, SMS message, or phone call) may be sent to the user regarding incoming transfers (e.g., “A cash transfer has been received on your secure payment account”), wherein the notification may include details regarding the transfer date/time, who made the transfer, card nickname or identifier, amount, or the like. Similarly, a notification may be sent to the user regarding outgoing transfers (e.g., “A case transfer had been made from your secure payment account”), wherein the notification may include details regarding the transfer date/time, who the transfer is being made to, card nickname or identifier, amount, etc. The notification for outgoing transfers may also include instructions to contact the secure payment system immediately if the user did not authorize the outgoing transfer.

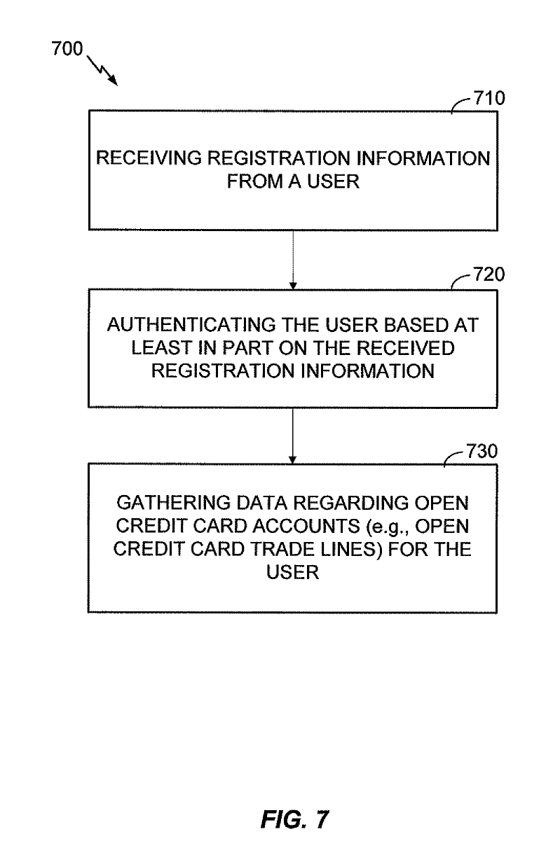

In accordance with one or more aspects of the subject of this disclosure, there is provided a method for secure online payments. With reference to FIG. 7, illustrated is a methodology 700 that may be performed at a registration server or the like in an e-commerce network. The method 700 may involve, at 710, receiving registration information from a user. The method 700 may involve, at 720, authenticating the user based at least in part on the received registration information. The method 700 may involve, at 730, gathering data regarding open credit card accounts (e.g., open credit card trade lines) for the user.

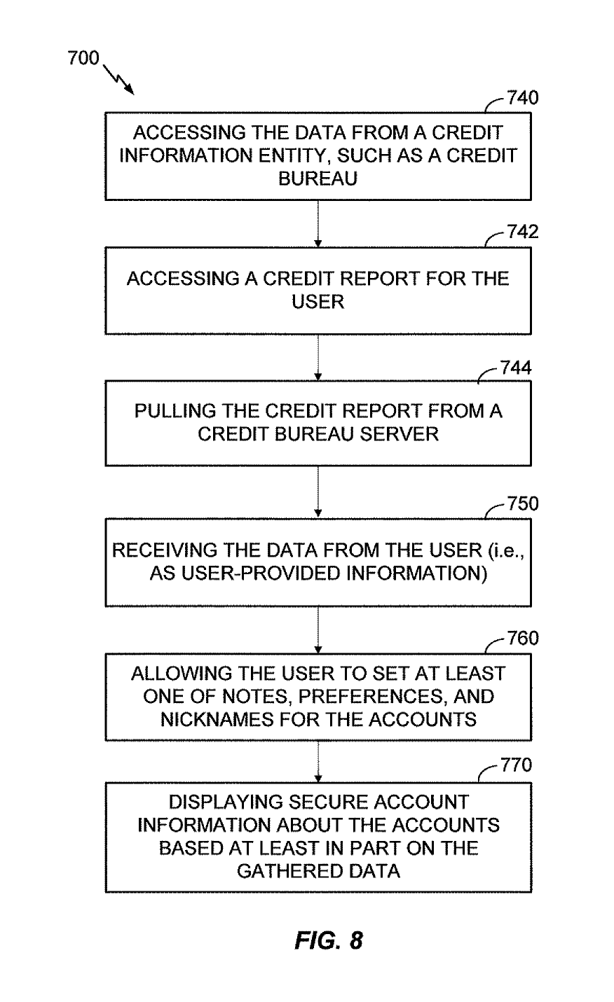

With reference to FIG. 8, gathering may further involve, at 740, accessing the data from a credit information entity, such as a credit bureau. Gathering may further involve, at 742, accessing a credit report for the user. Accessing the credit report may involve, at 744, pulling the credit report from a credit bureau server. In the alternative, or in addition, gathering may further involve, at 750, receiving the data from the user (i.e., as user-provided information). The method 700 may involve, at 760, allowing the user to set at least one of notes, preferences, and nicknames for the accounts. The method 700 may involve, at 770, displaying secure account information (e.g., a subset of the gathered data and/or truncated versions of credit card numbers for the accounts) about the accounts based at least in part on the gathered data.

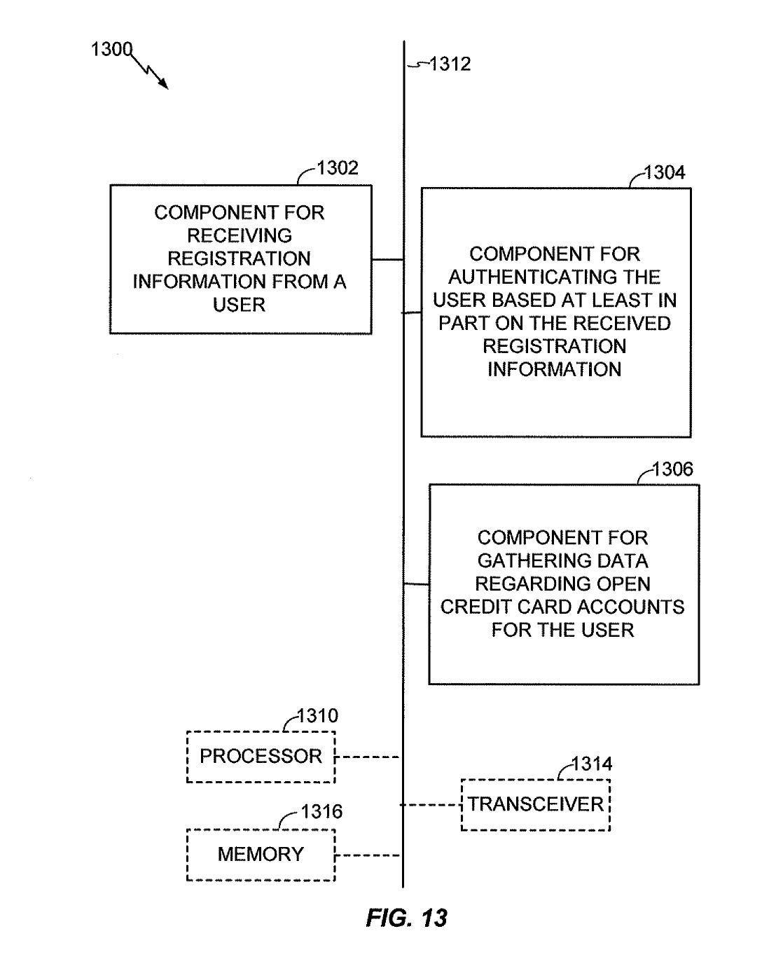

In accordance with one or more aspects of the embodiments described herein, there are provided devices and apparatuses secure online payments, as described above with reference to FIGS. 7-8. With reference to FIG. 13, there is provided an exemplary apparatus 1300 that may be configured as a registration server, or as a processor or similar device for use within the registration server. The apparatus 1300 may include functional blocks that can represent functions implemented by a processor, software, or combination thereof (e.g., firmware).

For example, the apparatus 1300 of FIG. 13 may comprise an electrical component or module 1302 for receiving registration information from a user. The apparatus 1300 may comprise an electrical component 1304 for authenticating the user based at least in part on the received registration information. The apparatus 1300 may comprise an electrical component 1306 for gathering data regarding open credit card accounts for the user.

In related aspects, the apparatus 1300 may optionally include a processor component 1310 having at least one processor, in the case of the apparatus 1300 configured as a network entity, rather than as a processor. The processor 1310, in such case, may be in operative communication with the components 1302-1306 via a bus 1312 or similar communication coupling. The processor 1310 may effect initiation and scheduling of the processes or functions performed by electrical components 1302-1306.

In further related aspects, the apparatus 1300 may include a communication or transceiver component 1314. A stand alone receiver and/or stand alone transmitter may be used in lieu of or in conjunction with the transceiver 1314. The apparatus 1300 may optionally include a component for storing information, such as, for example, a memory device/component 1316. The computer readable medium or the memory component 1316 may be operatively coupled to the other components of the apparatus 1300 via the bus 1312 or the like. The memory component 1316 may be adapted to store computer readable instructions and data for effecting the processes and behavior of the components 1302-1306, and subcomponents thereof, or the processor 1310, or the methods disclosed herein. The memory component 1316 may retain instructions for executing functions associated with the components 1302-1306. While shown as being external to the memory 1316, it is to be understood that the components 1302-1306 can exist within the memory 1316.

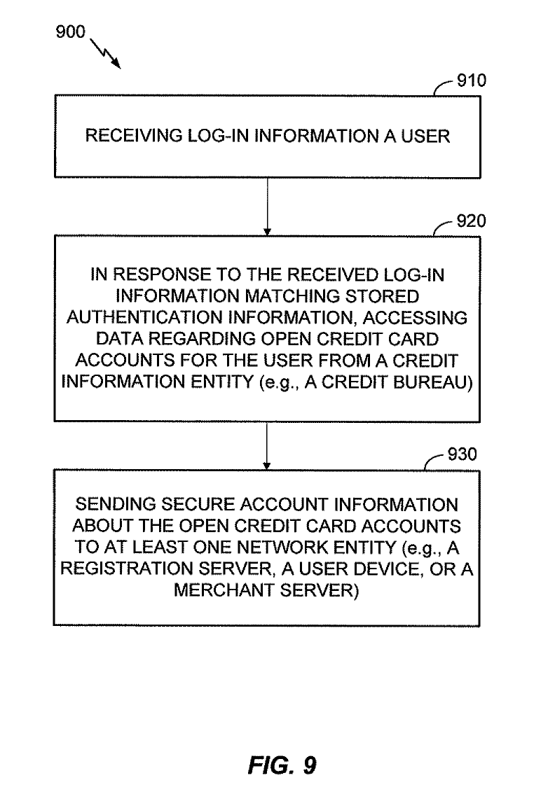

In accordance with one or more aspects of the embodiments described herein, there is provided a methodology operable by an authentication server or the like in an e-commerce network. With reference to FIG. 9, there is shown a method 900 that may involve, at 910, receiving log-in information for a user. The method 900 may involve, at 920, in response to the received log-in information matching stored authentication information, accessing data regarding open credit card accounts for the user from a credit information entity (e.g., a credit bureau). The method 900 may involve, at 930, sending secure account information about the open credit card accounts to at least one network entity (e.g., a registration server, a user device, or a merchant server).

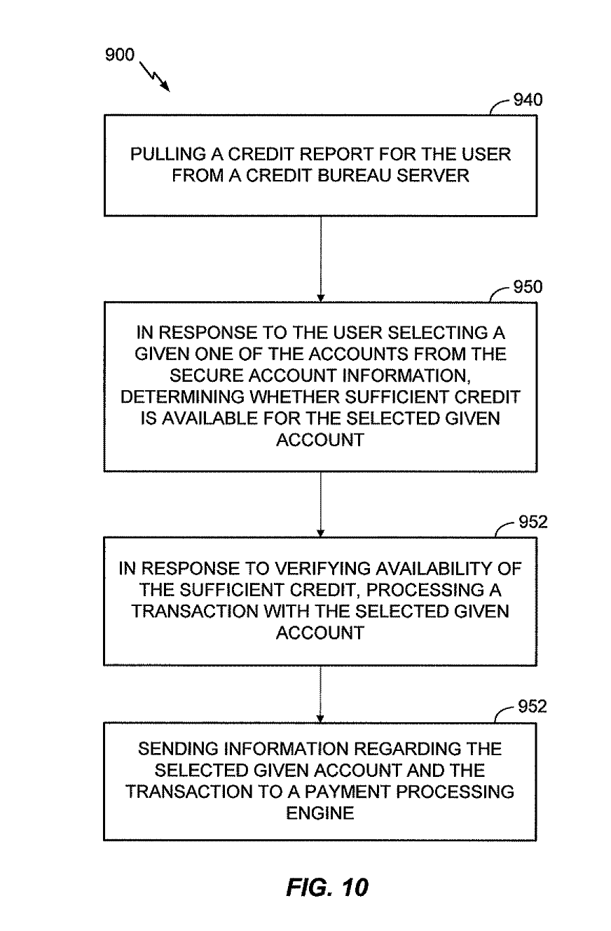

With reference to FIG. 10, accessing may involve, at 940, pulling a credit report for the user from a credit bureau server. The method 900 may involve, at 950, in response to the user selecting a given one of the accounts from the secure account information, determining whether sufficient credit is available for the selected given account. The method 900 may further involve, at 952, in response to verifying availability of the sufficient credit, processing a transaction with the selected given account. Processing the transaction may involve, at 954, sending information regarding the selected given account and the transaction to a payment processing engine.

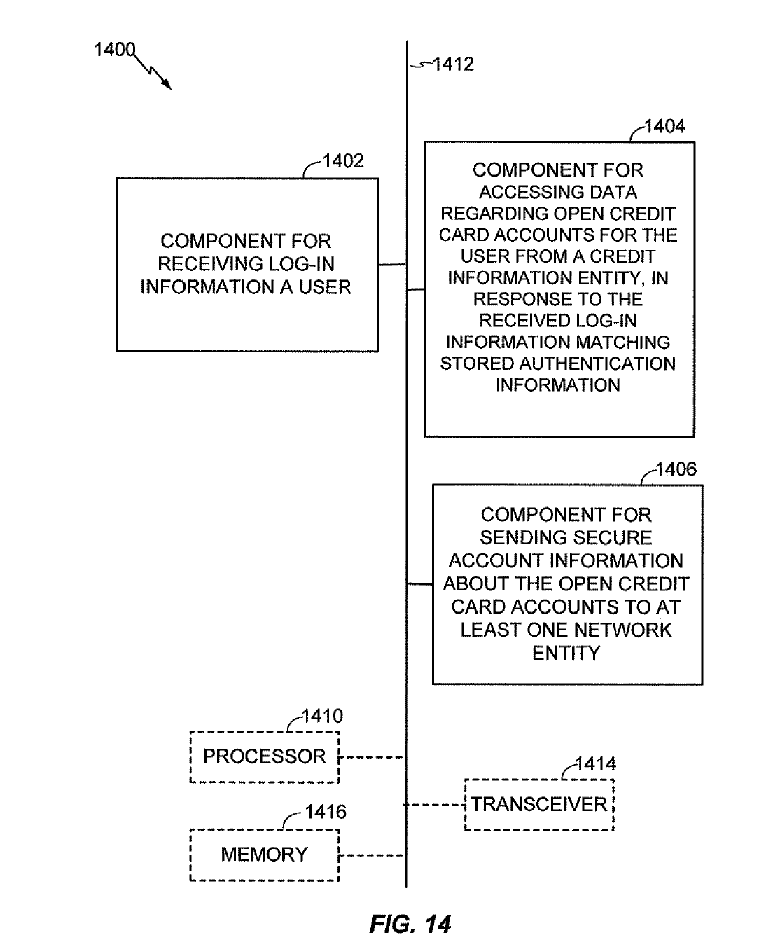

In accordance with one or more aspects of the embodiments described herein, there are provided devices and apparatuses (e.g., authentication servers or components thereof) for secure online payments, as described above with reference to FIGS. 9-10. With reference to FIG. 14, the apparatus 1400 may comprise an electrical component or module 1402 for receiving log-in information for a user. The apparatus 1400 may comprise an electrical component 1404 for accessing data regarding open credit card accounts for the user from a credit information entity, in response to the received log-in information matching stored authentication information. The apparatus 1400 may comprise an electrical component 1406 for sending secure account information about the open credit card accounts to at least one network entity. For the sake of conciseness, the rest of the details regarding apparatus 1400 are not further elaborated on; however, it is to be understood that the remaining features and aspects of the apparatus 1400 are substantially similar to those described above with respect to apparatus 1300 of FIG. 13.

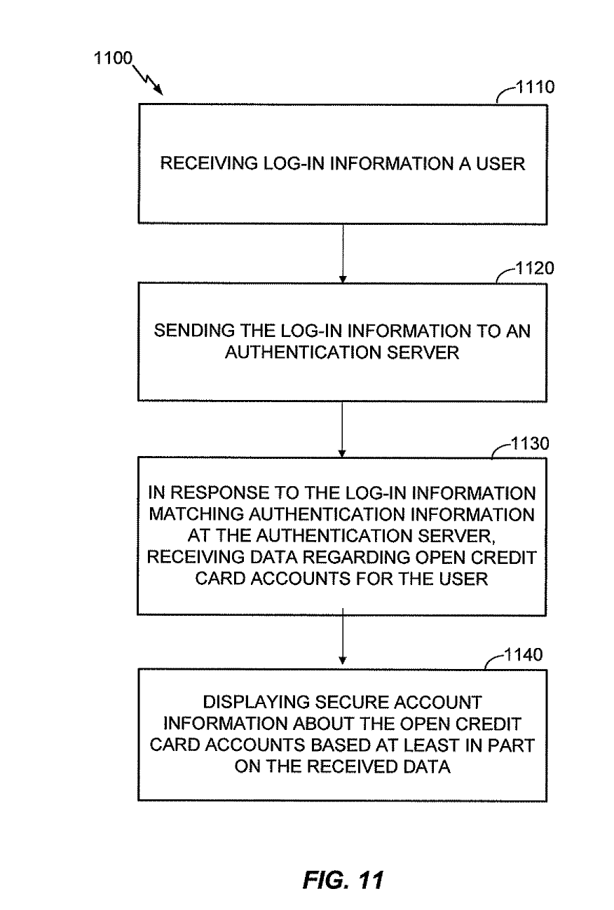

In accordance with one or more aspects of the embodiments described herein, there is provided a methodology operable by a user device. With reference to FIG. 11, there is shown a method 1100 that may involve, at 1110, receiving log-in information from a user. The method 1100 may involve, at 1120, sending the log-in information to an authentication server. The method 1100 may involve, at 1130, in response to the log-in information matching authentication information at the authentication server, receiving data regarding open credit card accounts for the user. The method 1100 may involve, at 1140, displaying secure account information about the open credit card accounts based at least in part on the received data. In related aspects, the received data may be based at least in part on a credit report for the user pulled from a credit bureau server. In further related aspects, the received data may be based at least in part user-provided information.

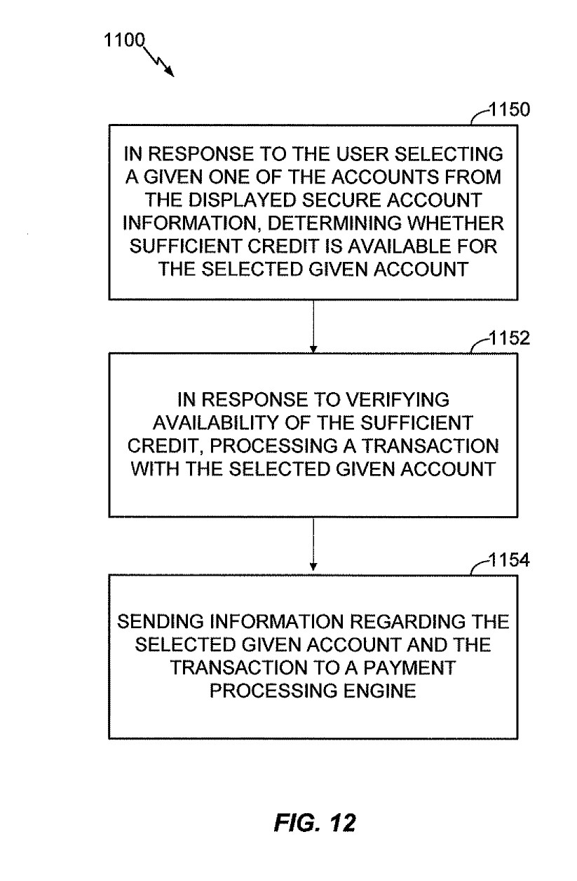

With reference to FIG. 12, the method 1100 may involve, at 1150, in response to the user selecting a given one of the accounts from the displayed secure account information, determining whether sufficient credit is available for the selected given account. The method 1100 may further involve, at 1152, in response to verifying availability of the sufficient credit, processing a transaction with the selected given account. Processing the transaction may involve, at 1154, sending information regarding the selected given account and the transaction to a payment processing engine.

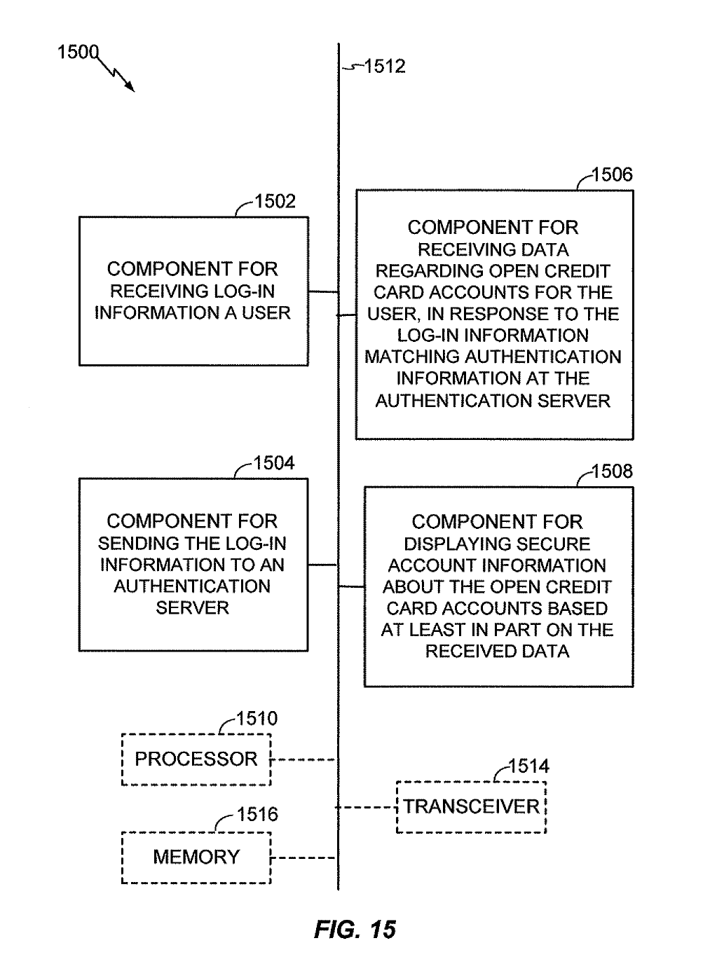

In accordance with one or more aspects of the embodiments described herein, there are provided devices and apparatuses (e.g., user devices or components thereof) for secure online payments, as described above with reference to FIGS. 11-12. With reference to FIG. 15, the apparatus 1500 may comprise an electrical component or module 1502 for receiving log-in information from a user. The apparatus 1500 may comprise an electrical component 1504 for sending the log-in information to an authentication server. The apparatus 1500 may comprise an electrical component 1506 for receiving data regarding open credit card accounts for the user, in response to the log-in information matching authentication information at the authentication server. The apparatus 1500 may comprise an electrical component 1508 for displaying secure account information about the open credit card accounts based at least in part on the received data. For the sake of conciseness, the rest of the details regarding apparatus 1500 are not further elaborated on; however, it is to be understood that the remaining features and aspects of the apparatus 1500 are substantially similar to those described above with respect to apparatus 1300 of FIG. 13.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, non-transitory signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes Compact Disc (CD), laser disc, optical disc, Digital Versatile Disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A method operable by a registration server, comprising:
receiving registration information from a user;
authenticating the user based at least in part on the received registration information; and
gathering data regarding open credit card accounts for the user.

2. The method of claim 1, wherein gathering comprises accessing the data from a credit information entity.

3. The method of claim 2, wherein accessing the data comprises accessing a credit report for the user.

4. The method of claim 3, wherein accessing the credit report comprises pulling the credit report from a credit bureau server.

5. The method of claim 1, wherein gathering comprises receiving the data from the user.

6. The method of claim 1, further comprising allowing the user to set at least one of notes, preferences, and nicknames for the accounts.

7. The method of claim 1, wherein the accounts comprise open credit card trade lines.

8. The method of claim 1, further comprising displaying secure account information about the accounts based at least in part on the gathered data.

9. The method of claim 8, wherein the secure account information comprises a subset of the gathered data.

10. The method of claim 9, wherein the subset comprises truncated versions of credit card numbers for the accounts.

11. An apparatus, comprising:
at least one processor configured to: receive registration information from a user; authenticate the user based at least in part on the received registration information; and gather data regarding open credit card accounts for the user; and
a memory coupled to the at least one processor for storing data.

12. The apparatus of claim 11, wherein the at least one processor gathers by accessing the data from a credit information entity.

13. The apparatus of claim 12, wherein the at least one processor accesses a credit report for the user.

14. The apparatus of claim 13, wherein the at least one processor pulls the credit report from a credit bureau server.

15. The apparatus of claim 11, wherein the at least one processor gathers by receiving the data from the user.

16. A computer program product, comprising:
a computer-readable medium comprising code for causing a computer to:
receive registration information from a user;
authenticate the user based at least in part on the received registration information; and
gather data regarding open credit card accounts for the user.

17. A method operable by an authentication server, comprising:
receiving log-in information for a user;
in response to the received log-in information matching stored authentication information, accessing data regarding open credit card accounts for the user from a credit information entity; and
sending secure account information about the open credit card accounts to at least one network entity.

18. The method of claim 17, wherein:
the credit information entity comprises a credit bureau; and
accessing the data comprises pulling a credit report for the user from a credit bureau server.

19. The method of claim 17, wherein the at least one network entity comprises one of a registration server, a user device, and a merchant server.

20. The method of claim 17, further comprising:
in response to the user selecting a given one of the accounts from the secure account information, determining whether sufficient credit is available for the selected given account; and
in response to verifying availability of the sufficient credit, processing a transaction with the selected given account.

21. The method of claim 20, wherein processing the transaction comprises sending information regarding the selected given account and the transaction to a payment processing engine.

22. An apparatus, comprising:
at least one processor configured to: receive log-in information for a user; in response to the received log-in information matching stored authentication information, access data regarding open credit card accounts for the user from a credit information entity; and send secure account information about the open credit card accounts to at least one network entity; and
a memory coupled to the at least one processor for storing data.

23. The apparatus of claim 22, wherein:
the credit information entity comprises a credit bureau; and
the at least one processor accesses the data comprises pulling a credit report for the user from a credit bureau server.

24. The apparatus of claim 22, wherein the at least one network entity comprises one of a registration server, a user device, and a merchant server.

25. A computer program product, comprising:
a computer-readable medium comprising code for causing a computer to:
receive log-in information for a user;
in response to the received log-in information matching stored authentication information, access data regarding open credit card accounts for the user from a credit information entity; and
send secure account information about the open credit card accounts to at least one network entity.

26. A method operable by a user device, comprising:
receiving log-in information from a user;
sending the log-in information to an authentication server;
in response to the log-in information matching authentication information at the authentication server, receiving data regarding open credit card accounts for the user; and
displaying secure account information about the open credit card accounts based at least in part on the received data.

27. The method of claim 26, wherein the received data is based at least in part on a credit report for the user pulled from a credit bureau server.

28. The method of claim 26, wherein the received data is based at least in part on user-provided information.

29. The method of claim 26, wherein the secure account information comprises a subset of the received data.

30. The method of claim 26 further comprising:
in response to the user selecting a given one of the accounts from the displayed secure account information, determining whether sufficient credit is available for the selected given account; and
in response to verifying availability of the sufficient credit, processing a transaction with the selected given account.

31. The method of claim 30, wherein processing the transaction comprises sending information regarding the selected given account and the transaction to a payment processing engine.

32. An apparatus, comprising:
at least one processor configured to: receive log-in information from a user; send the log-in information to an authentication server; in response to the log-in information matching authentication information at the authentication server, receive data regarding open credit card accounts for the user; and display secure account information about the open credit card accounts based at least in part on the received data; and
a memory coupled to the at least one processor for storing data.

33. The apparatus of claim 32, wherein the received data is based at least in part on a credit report for the user pulled from a credit bureau server.

34. The apparatus of claim 32, wherein the received data is based at least in part on user-provided information.

35. A computer program product, comprising:
a computer-readable medium comprising code for causing a computer to:
receive log-in information from a user;
send the log-in information to an authentication server;
in response to the log-in information matching authentication information at the authentication server, receive data regarding open credit card accounts for the user; and
display secure account information about the open credit card accounts based at least in part on the received data.
